(19) United States
(12) Patent Application Publication
(10) Pub. No.: US 2001/0056305 A1
(43) Pub. Date: Dec. 27, 2001

(54) Electronic device, user identification assisting device, appliance management device, electronic device management system, and appliance management system

(76) Inventors: Koichi Moriya, Mihama-ku (JP); Akira Sugiyama, Mihama-ku (JP); Jun Hirotomi, Mihama-ku (JP); Toshiya Kanesaka, Mihama-ku (JP); Kazuhiro Koyama, Mihama-ku (JP); Toshiyuki Fujiwara, Mihama-ku (JP); Kaori Takano, Mihama-ku (JP)

Correspondence Address: ADAM & WILKS, ATTORNEYS AND COUNSELORS AT LAW, 31st FLOOR, 50 BROADWAY, NEW YORK, NY, 10004, US

(21) Appl. No.: 09/861,305

(22) Filed: May 18, 2001

(30) Foreign Application Priority Data
Jun. 2, 2000 (JP) 2000-166212
Jul. 7, 2000 (JP) 2000-207279

(51) Int. Cl. G05B 11/01

(52) U.S. Cl. 700/23

(57) ABSTRACT

An appliance management system includes an electronic device having some functions useful to a user, and an appliance management device designed to be always carried by the user. The electronic device receives a predetermined signal from the appliance management device, and extracts an ID code of the appliance management device. The electronic device becomes unusable when the signal receiving condition is bad. The functions of the electronic device are restricted according to the result of collation between management information registered in the electronic device and the ID code in the received signal.

### BACKGROUND OF THE INVENTION

1. Field of the Invention

The present invention relates to an electronic device, a user identification assisting device, and an electronic device management system, which devices and system are arranged to prevent unauthorized use of the electronic device by identifying a person authorized to use the electronic device.

The present invention also relates to an electronic device, an appliance management device and an appliance management system which are arranged to prevent mislaying or loss of various appliances.

2. Description of the Related Art

Various kinds of information processors which have recently sprung into wide use are now becoming indispensable even to ordinary people's lives. Conventional information processors similar in function to those recently developed are comparatively large in size and are ordinarily used only in a state of being placed on a desk in an office or the like. Therefore such information processors can be stolen only in restricted situations. When such an information processor is stolen, the owner of the information processor can immediately notice the theft. Also, use of conventional information processors is limited to ordinary information processing, e.g., making and maintenance of a list of names, calculation and the like.

With the recent rapid progress of relating technologies, various portable information processors, e.g., portable telephones and personal data assistants (PDAs), have been developed. There is an increased possibility of such information processors being lost or stolen since they are ordinarily used in a carried state. Moreover, when a portable information processor is stolen, it is not always possible for the owner of it to immediately notice the theft. That is, noticing the occurrence of theft and taking action on the theft is extended under such circumstances. Also, recent information processors, particularly portable information processors are capable of accessing various network services as well as conventional functions. In many cases, there is a charge for gaining access to such a network service. Even an information processor capable of accessing a bank account or the like has been provided. Therefore there is a possibility of the contents of damage from theft becoming much more serious than before.

Many of information processors recently developed, therefore, have a system in which a password or the like is used for prevention of unauthorized use of the information processor as insurance against a situation such as theft and loss.

The method of using a password for prevention of unauthorized use in the conventional art entails problems described below.

When a protective function using a password is on in an information processor, a person who wishes to use the information processor must input the password. That is, even a person authorized to use the information processor must input the password, and therefore the authorized user cannot immediately start using the information processor when he or she wants to use the information processor. Also, inputting a password is somewhat troublesome. Further, in general, the reliability of protection by a password is improved if the password is longer. However, there is a certain limit to the length of a password in relation to the human retentive faculty.

There has been no means for eliminating the inconvenience of such setting and use of a password except stopping the protective function using a password. That is, security and convenience are alternative selections for users. Thus, the conventional protection system using a password cannot be recognized as satisfactory in terms of both security and convenience. Also, the same antinomy between convenience and security also exists with respect to other various electronic devices.

### SUMMARY OF THE INVENTION

In view of the above-described circumstances, an object of the present invention is to provide an electronic device, a user identification assisting device and an electronic device management system which are arranged so that unauthorized use of the electronic device can be prevented with improved reliability while the convenience of the electronic device is maintained.

Then, in view of the need for means for preventing theft or loss of recent information appliances, another object of the present invention is to provide an electronic device, an appliance management device and an appliance management system, which are arranged to prevent mislaying or loss of appliances.

To achieve the above-described objects, according to one aspect of the present invention, there is provided an electronic device characterized by comprising processing means arranged so as to be able to execute desired processing, receiving means for receiving a predetermined signal, receiving condition determination means for determining the condition of receiving of the predetermined signal performed by the receiving means, and restriction means for restricting the processing executed by the processing means if the receiving condition determination means determines that the condition of receiving is worse than a predetermined condition.

According to the present invention, the receiving means receives the predetermined signal, and the receiving condition determination means determines the condition of receiving of the predetermined signal performed by the receiving means. If the receiving condition thereby determined is bad, the restriction means restricts the processing performed by the processing means.

According to another aspect of the present invention, there is provided an electronic device characterized by comprising processing means arranged so as to be able to execute desired processing, receiving means for receiving a signal containing a predetermined discrimination code, extraction means for extracting the discrimination code from the signal received by the receiving means, memory means for storing management information including one or more predetermined discrimination codes (hereinafter referred to as “registered code”), collation means for collating the discrimination code extracted by the extraction means (hereinafter referred to as “received code”) with the registered code, and restriction means for restricting the processing executed by the processing means if there is no match between the received code and any registered codes as a result of the collation by the collation means.

According to the present invention, the receiving means receives a signal containing a predetermined discrimination code, the extraction means extracts the discrimination code from the signal received by the receiving means, and the collation means collates the received code with the registered codes. If there is no match between the received code and any registered codes as a result of the collation by the collation means, the restriction means restricts the processing executed by the processing means.

Specifically, the above-described electronic device in accordance with the present invention is characterized in that, the management information is formed in such a manner that the registered codes and the contents of restrictions with respect to the registered codes are related to each other, and the restriction means restricts the processing executed by the processing means according to the contents of the management information if there is a match between the received code and any one of the registered codes as a result of the collation by the collation means.

According to the present invention, the registered codes and the contents of restriction with respect to the registered codes are related to each other in the management information. If there is a match between the received code and any one of the registered codes as a result of the collation by the collation means, the restriction means restricts the processing executed by the processing means according to the contents of the management information.

The above-described electronic device according to the present invention is characterized by further comprising registration means for accepting registration of a code entered as the discrimination code by a user, and for registering the entered discrimination code in the management information.

According to the present invention, the registration means accepts registration of a discrimination code entered by a user, and registers the accepted content in the management information.

Specifically, the above-described electronic device according to the present invention is characterized in that, the processing means is arranged so as to be able to execute at least one of processing of data and/or a signal, and processing for transmitting a wireless signal.

According to the present invention, the processing means executes at least one of processing of data and/or a signal, and processing for transmitting a wireless signal. That is, this electronic device is an information processor or a communication terminal.

According to still another aspect of the present invention, there is provided a user identification assisting device characterized by comprising a discrimination code memory means having a predetermined discrimination code stored therein in advance, transmitting means for transmitting a signal containing the discrimination code, and wearing means for enabling the user identification assisting device to be worn about the body or on a garment of a user.

According to the present invention, the user identification assisting device is worn about the body or on a garment of a user by using the wearing means. In this state, a predetermined discrimination code is stored in the discrimination code memory means in advance. The transmitting means transmits a signal containing this discrimination code.

According to yet another aspect of the present invention, there is provided an electronic device management system characterized by comprising the above-described electronic device, and the above-described user identification assisting device.

According to the present invention, the processing executed in the electronic device is restricted according to a signal (or a discrimination code) transmitted from the user identification assisting device.

To achieve the above-described objects, according to a further aspect of the present invention, there is also provided an appliance management device for managing an electronic device, characterized by comprising the appliance management device comprising inquiry means for inquiring of the electronic device about the presence/absence of the electronic device, response detection means for detecting a response from the electronic device to the inquiry, determination means for making a determination as to whether the electronic device is out of a control zone of the appliance management device on the basis of a result of detection performed by the response detection means, and notifying means for issuing information that the electronic device is out of the control zone if the determination means determines that electronic device is out of the control zone.

According to the invention, the inquiry means inquires of the management-object electronic device about the presence/absence of the same. The response detection means detects a response from the electronic device to the inquiry. The determination means makes a determination as to whether the electronic device is out of the control zone of the appliance management device on the basis of the result of detection performed by the response detection means. If the determination means determines that the electronic device is out of the control zone, the notifying means issues information that the electronic device is out of the control zone.

According to the invention in the appliance management device, the inquiry means is characterized in that it includes a management device code holding means for holding in advance a discrimination code unique to the appliance management device (hereinafter referred to as “management device code”), and transmitting means for transmitting the management device code.

According to the invention, the inquiry means makes an inquiry as described below. That is, a discrimination code unique to the appliance management device (management device code) is stored in the management device code holding means in advance. The transmitting means transmits the management device code.

According to the invention in the appliance management device, the transmitting means is characterized in that it transmits the management device code at every predetermined time interval.

According to the invention, the transmitting means transmits the management device code at every predetermined time intervals.

Alternatively, the transmitting means may continuously transmit the management device code.

According to the invention in the appliance management device, the determination means is characterized in that it determines that the electronic device is out of the control zone if the response detection means does not detect the response in a predetermined time period after the transmission of the management device code performed by the transmitting means.

According to the invention, if the response detection means does not detect the response in the predetermined time period after the transmission of the management device code performed by the transmitting means, the determination means determines that the electronic device is out of the control zone.

According to the invention, the appliance management device further is characterized in that it comprises appliance code memory means for storing registered information containing discrimination codes unique to one or more electronic devices to be managed (hereinafter referred to as “appliance code”), and the response detection means receives a signal containing a discrimination code and extracts the discrimination code from the received signal, and the determination means collates the discrimination code extracted by the response detection means with the registered information, and for the appliance code corresponding to one of the electronic devices having the appliance codes contained in the registered information is not detected by the response detection means, the determination means determines that the response has not been detected from the electronic device, and that the electronic device is out of the control zone.

According to the invention, registered information containing discrimination codes unique to one or more electronic devices to be managed (appliance codes) is stored in the appliance code memory means. The response detection means receives a signal containing a discrimination code and extracts the discrimination code from the received signal. The determination means collates the discrimination code extracted by the response detection means with the registered information. If the appliance code corresponding to one of the electronic devices having the appliance codes contained in the registered information is not detected by the response detection means as a result of collation, the determination means determines that the response has not been detected from the electronic device, and that the electronic device is out of the control zone.

According to the invention , the appliance management device is characterized in that, the registered information is formed in such a manner that the discrimination codes unique to the electronic devices to be managed and the kinds or names of the electronic devices corresponding to the discrimination codes are related to each other, and the notifying means issues information on the kind or the name of some of the electronic devices recognized as existing out of the control zone by the determination means.

According to the invention, the discrimination codes unique to the electronic devices to be managed and the kinds or names of the electronic devices corresponding to the discrimination codes are related to each other in the registered information. The notifying means issues information on the kind or the name of some of the electronic devices recognized as existing out of the control zone by the determination means.

According to the invention, the appliance management device further is characterized by comprising registration means for accepting an instruction from a user to register a discrimination code as the discrimination code of the electronic devices, and for registering the discrimination code in the registered information.

According to the invention, the registration means accepts an instruction from a user to register a discrimination code as the discrimination code of the electronic devices, and registers the discrimination code in the registered information.

According to the invention, the appliance management device further comprises wearing means for enabling the appliance management device to be worn about the body or on a garment of a user.

According to the invention, the application management device is worn about the body or on a garment of a user by using the wearing means.

According to still a further aspect of the present invention, there is provided an electronic device managed by an appliance management device, the electronic device characterized by comprising inquiry detection means for detecting an inquiry from the appliance management device, self-determination means for making a determination as to whether the electronic device is out of a control zone of the appliance management device on the basis of a result of detection performed by the inquiry detection means, and processing means for performing predetermined processing if the self-determination means determines that the electronic device is out of the control zone.

According to the invention, the inquiry detection means detects an inquiry from the appliance management device, and the self-determination means makes a determination as to whether the electronic device is out of a control zone of the appliance management device on the basis of the result of detection performed by the inquiry detection means. If it is determined that the electronic device is out of the control zone, the processing means performs predetermined processing.

According to the invention, the electronic device is characterized in that, the processing means performs at least one of speech generation processing for generating sound if the self-determination means determines that the electronic device is out of the control zone, and position detecting and notifying processing for detecting the position of the electronic device and notifying the detected position if the self-determination means determines that the electronic device is out of the control zone.

According to the invention, the processing means performs at least one of the sound generation processing and the position detecting and notifying processing if the self-determination means determines that the electronic device is out of the control zone.

According to the invention, the electronic device is characterized in that, the self-determination means determines that the electronic device is out of the control zone if the inquiry detection means does not detect the inquiry in every predetermined time period.

According to the invention, if the inquiry detection means does not detect the inquiry in every predetermined time period, the self-determination means determines that the electronic device is out of the control zone.

According to the invention, the electronic device is characterized in that it further comprises management device code memory means for storing a discrimination code unique to the appliance management device managing the electronic device (hereinafter referred to as “management device code”), the inquiry detection means receives a signal containing a discrimination code, and extracts the discrimination code from the received signal, the self-determination means collates the discrimination code extracted by the inquiry detection means with the management device code, and if there is no match between the management device code and any of discrimination codes extracted by the inquiry detection means in the predetermined time period as a result of the collation, the determination means determines that the inquiry has not been detected, and that the electronic device is out of the control zone.

According to the invention, the management device code memory means contains a discrimination code unique to the appliance management device managing the electronic device (management device code). The inquiry detection means receives a signal containing a discrimination code, and extracts the discrimination code from the received signal. The self-determination means collates the discrimination code extracted by the inquiry detection means with the management device code. If there is no match between the management device code and any of discrimination codes extracted by the inquiry detection means in the predetermined time period as a result of the collation, the determination means determines that the inquiry has not been detected, and that the electronic device is out of the control zone.

According to the invention, the electronic device is characterized in that it further comprises management device code registration means for accepting an instruction from a user to register a management device code, and for registering the management device code in the management device code memory means.

According to the invention, the management device code registration means accepts an instruction from a user to register a management device code, and registers the management device code in the management device code memory means.

According to the invention, the electronic device is characterized in that it further comprises appliance code holding means for holding in advance a discrimination code unique to the electronic device (hereinafter referred to as “appliance code”), and appliance code transmitting means for transmitting the appliance code to the appliance management device if the self-determination means determines that the electronic device is within the control zone of the appliance management device.

According to the invention, the appliance code holding means holds in advance a discrimination code unique to the electronic device (appliance code), and the appliance code transmitting means transmits the appliance code to the appliance management device if the self-determination means determines that the electronic device is within the control zone of the appliance management device.

According to still a further aspect of the present invention, there is provided an appliance management system characterized by comprising the appliance management device and the electronic device.

According to the invention, the appliance management device makes an inquiry to the electronic device, and makes a determination as to whether the electronic device is within the control zone on the basis of a response to the inquiry. On the other hand, the electronic device makes a determination as to whether the electronic device itself is located within the control zone on the basis of existence/nonexistence of the inquiry from the appliance management device.

### BRIEF DESCRIPTION OF THE DRAWINGS

In the accompanying drawings

FIG. 1 is a diagram showing the entire configuration of an information processor management system which represents an embodiment of the present invention;

FIG. 2 is a block diagram showing the configuration of an internal functional section of a user identification assisting device;

FIG. 3 is a block diagram of the configuration of internal functional sections of an information processor;

FIG. 4 is a flowchart of a process performed by the user identification assisting device;

FIG. 5 is a flowchart of a process performed by the information processor;

FIG. 6 is a block diagram of the configuration of internal functional sections of a user identification assisting device;

FIG. 7 is a block diagram of the configuration of internal functional sections of an information processor;

FIG. 8 is a diagram representing an ID code registration table;

FIG. 9 is a flowchart of a process performed by the user identification assisting device;

FIG. 10 is a flowchart of a process performed by the information processor;

FIG. 11 is a diagram showing the entire configuration of an appliance management system which represents an embodiment of the present invention;

FIG. 12 is a block diagram showing the configuration of internal functional sections of an appliance management device;

FIG. 13 is a diagram representing an ID code registration table;

FIG. 14 is a block diagram showing the configuration of internal functional sections of an information appliance;

FIG. 15 is a flowchart of an inquiry process performed by the appliance management device;

FIG. 16 is a flowchart of a response process performed by the information appliance;

FIG. 17 is a flowchart of a registration process;

FIG. 18 is a diagram showing an example of application of the appliance management system in this embodiment;

FIG. 19 is a diagram showing another example of application of the appliance management system in this embodiment; and

FIG. 20 is a diagram showing still another example of application of the appliance management system in this embodiment.

### DESCRIPTION OF THE PREFERRED EMBODIMENTS

Embodiments of the present invention will be described with reference to the accompanying drawings. Needless to say, the embodiments described below are not to be construed as limiting the present invention.

Embodiment 1

An information processor management system in this embodiment is characterized by being arranged to enable an information processor 100 to be used only when the information processor 100 is receiving electric waves transmitted from a user identification assisting device 200, as described below in detail.

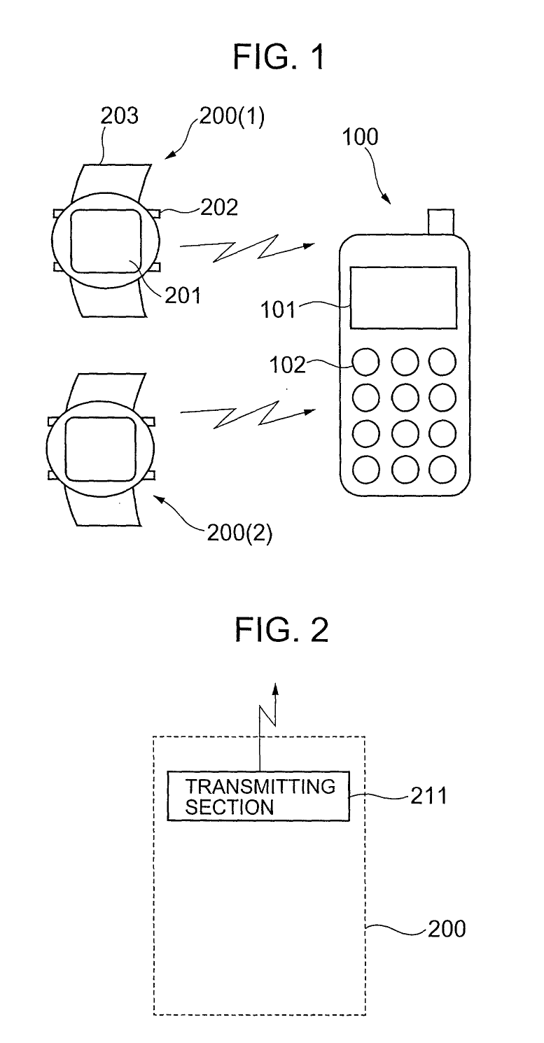

This information processor management system will first be described with reference to FIGS. 1, 2, and 3.

As shown in FIG. 1, this system comprises a portable information processor 100 and a user identification assisting device 200 used for management of use of the information processor 100.

As user identification assisting device 200, user identification assisting devices 200(1) and 200(2) are provided each of which informs the information processor 100 that a person carrying the user identification assisting device 200(1) or 200(2) is an authorized user (a person having the right to use the information processor 100). In the following description, when there is no need to discriminate the user identification assisting devices 200(1) and 200(2) from each other, each user identification assisting device is referred to simply as user identification assisting device 200. The user identification assisting device 200 has as its component a transmitting section 211 to transmitting a predetermined signal, as shown in FIG. 2. The transmitting section 211 is arranged to repeat transmitting the signal at predetermined time intervals (or at all times) through a spatial surrounding the device. The transmitting section 211 has low transmit power such that the coverage of transmitted signal is limited to several ten centimeters to several meters. In addition the user identification assisting device 200 also has a clock display function. To perform this function, the user identification assisting device 200 has a display section 201, operating portions 202, etc., (shown not in FIG. 2 but in FIG. 1). Further, the user identification assisting device 200 has a belt 203 for wearing about a wrist.

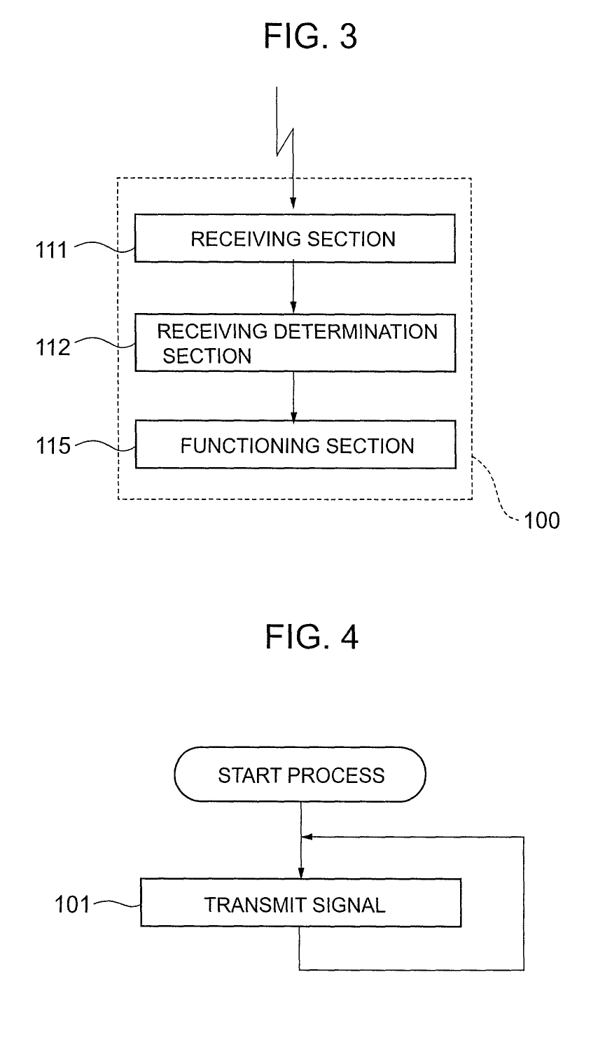

The information processor 100 has various information processing functions (e.g., the functions of an ordinary portable telephone). The information processor 100 has an unauthorized use prevention function such as to be used only by a person having the right to use the information processor 100. This unauthorized use prevention function is performed according to the condition of receiving of the above-described signal transmitted from the user identification assisting device 200. That is, the information processor 100 is arranged so as to be usable only when the predetermined signal transmitted from the user identification assisting device 200 is received by the information processor 100. When this signal is not received, the information processor 100 cannot be used. As shown in FIG. 3, the information processor 100 has, in its internal configuration, a receiving section 111 for receiving the signal transmitted from the user identification assisting device 200, and a receiving determination section 112 for determining the condition of receiving of the signal, and a functioning section 115.

The receiving determination section 112 determines the condition of receiving of the signal by the receiving section 111. The receiving determination section 112 has in its internal portion a value (reference value) to be referred to for determination of the intensity of a signal. The receiving determination section 112 compares this reference value and the intensity of a signal input from the receiving section 111 to determine the condition of receiving of the signal.

The functioning section 115 has various data processing functions corresponding to the functions of an ordinary portable telephone, and also has various data processing functions. The performance of these functions is limited according to the result (good/not good) of determination made by the receiving determination section 112. Although the functioning section 115 is represented by only one block in FIG. 3, it includes, in reality, various devices (e.g., a display 101, operating portions 102 (see FIG. 1), a microphone, a speaker, a buzzer, a signal and data processing circuit, and a wireless signal transmitting and receiving circuit).

The above-described sections constituting the information processor 100 are specifically realized as memories, such as a read-only memory (ROM) and a random-access memory (RAM), in which data for various controls, programs, etc., are stored, a central processing unit (CPU) for realizing the various functions by executing the programs, transmitting and receiving circuits, etc.

“Processing means” referred to in the appended claims of the present invention corresponds to the functioning section 115 in this embodiment. “Receiving means” corresponds to the receiving section 111. “Receiving condition determination means” corresponds to the receiving determination section 112. “Restriction means” corresponds to the receiving determination section 112. However, the above-described sections operate in intimate association with each other and the sections of this embodiment and the means described in the claims are not to be construed as corresponding strictly to each other as described above.

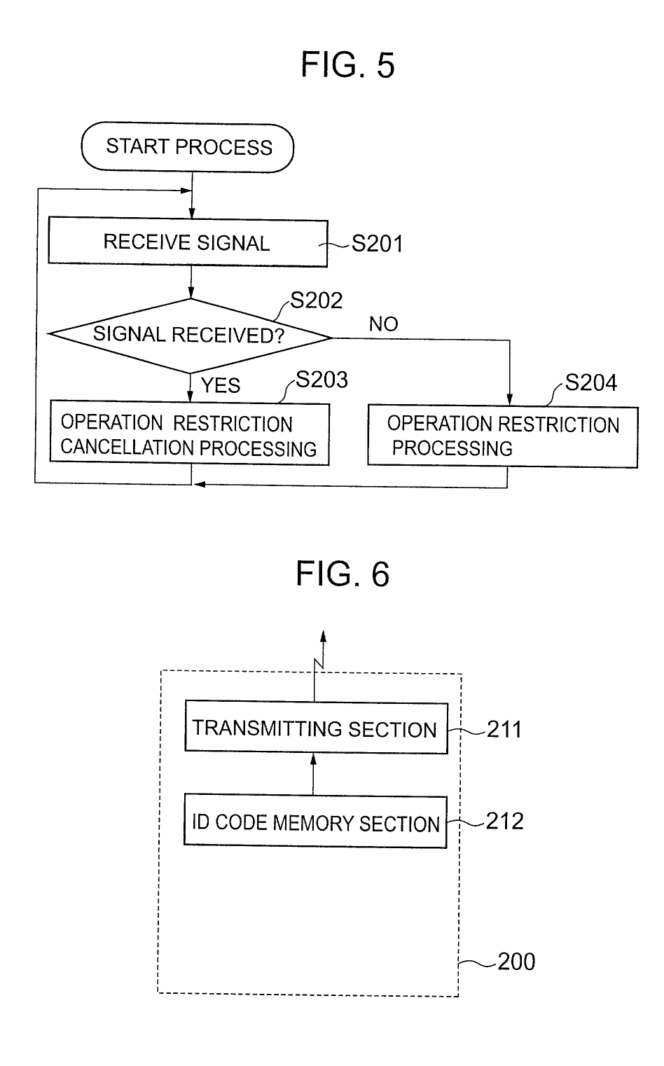

The operation of this system will now be described below with reference to FIGS. 4 and 5 with respect to an unauthorized use prevention process.

The unauthorized use prevention function in this system is performed by the information processor 100 and the user identification assisting device 200 operating in association with each other. However, the operation of the information processor 100 and the operation of the user identification assisting device 200 will be described separately from each other.

The operation of the user identification assisting device 200 will first be described with reference to FIGS. 4.

The user identification assisting device 200 is worn (or fitted) about a wrist of a user like an ordinary wristwatch, with its belt 203 encircling the wrist. In this state, the transmitting section 211 of the user identification assisting device 200 is transmitting a predetermined signal to a surrounding space at predetermined time intervals (e.g., several seconds) (step S101).

The operation of the information processor 100 will next be described with reference to FIGS. 5.

In the information processor 100, the receiving section 111 is operating continuously to receive the signal transmitted from the user identification assisting device 200 (step S201). The receiving determination section 112 determines the condition of receiving of the signal by the receiving section 111 (step S202). This determination is made according to whether the intensity of the received signal is higher or lower than the predetermined reference value.

If the result of this determination is that the desired receiving result has been obtained (good receiving condition), the functioning section 115 is permitted to operate or restrictions on the functions are canceled (step S203), thereby enabling the person wearing the user identification assisting device 200 (i.e., the person having the right to use the information processor 100) to use the information processor 100.

On the other hand, if the result of the determination in step S202 is that the desired receiving result has not been obtained (bad receiving condition), processing operations which the information processor 100 can perform are restricted and the buzzer is sounded (step S204), thereby restricting use of the information processor 100 with respect to all the functions thereof. The information processor 100 can inform the user that its use is restricted. Thus, a person carrying no user identification assisting device 200 (i.e., a person having no authentic right to use the information processor 100) cannot use the information processor 100.

After step S203 or step S204, the process returns to step S201. The information processor 100 and the user identification assisting device 200 continually repeat the above-described steps during operation.

In this embodiment, as described above, only a person wearing the user identification assisting device 200 can use the information processor 100. Therefore, even when the information processor 100 is lost or in a like situation, there is no possibility of the information processor 100 being used by an unauthorized person. The person wearing the user identification assisting device 200 can use the information processor 100 without performing any special unlocking operation or the like. Thus, the desired operability of the information processor 100 is maintained.

Like an ordinary wristwatch, the user identification assisting device 200 can be worn with its belt 203 fitted around a wrist. Therefore, the user identification assisting device 200 does not interfere with the user's ordinary bodily actions, and the possibility of loss or the like of the user identification assisting device 200 is low.

In this embodiment, all the functions are restricted when the signal from the user identification assisting device 200 is not received. However, the information processor 100 may be enabled to operate only for a call to the police, a fire department or the like in case of emergency.

Means for signal exchange between the information processor 100 and the user identification assisting device 200 are not particularly specified. For example, signal exchange means in accordance with Bluetooth in the course of standardization by a certain number of companies at present may be used.

Embodiment 2

An information processor management system in Embodiment 2 is based on the same concept as that in Embodiment 1. However, an essential feature of Embodiment 2 resides in that an identification code (ID code) is transmitted from a user identification assisting device 200 to finely control use of an information processor 100, as described below in detail.

Components of Embodiment 2 having the same functions as those of Embodiment 1 are indicated by the same reference characters, and the description for them will not be repeated. Embodiment 2 will be described mainly with respect to points of difference from Embodiment 1.

The user identification assisting device 200 is a device for informing the information processor 100 that a person carrying the user identification assisting device 200 is an authorized user (a person having the right to use the information processor 100). As shown in FIG. 6, the user identification assisting device 200 in Embodiment 2 has an ID code memory section 212 as well as the same components as those of Embodiment 1 (described above with reference to FIG. 2). An ID code unique to the user identification assisting device 200 is stored in the ID code memory section 212. The specific value of the ID code is fixed at factory-shipment and cannot be changed by the user. The ID code memory section 212 is constituted by, for example, a read-only memory. The transmitting section 211 repeats transmitting a signal carrying the ID code stored in the ID code memory section 212 to a surrounding space in a predetermined interval. In other respects (for example, with respect to limitation of the transmitting power of the transmitting section 211), Embodiment 2 is the same as Embodiment 1.

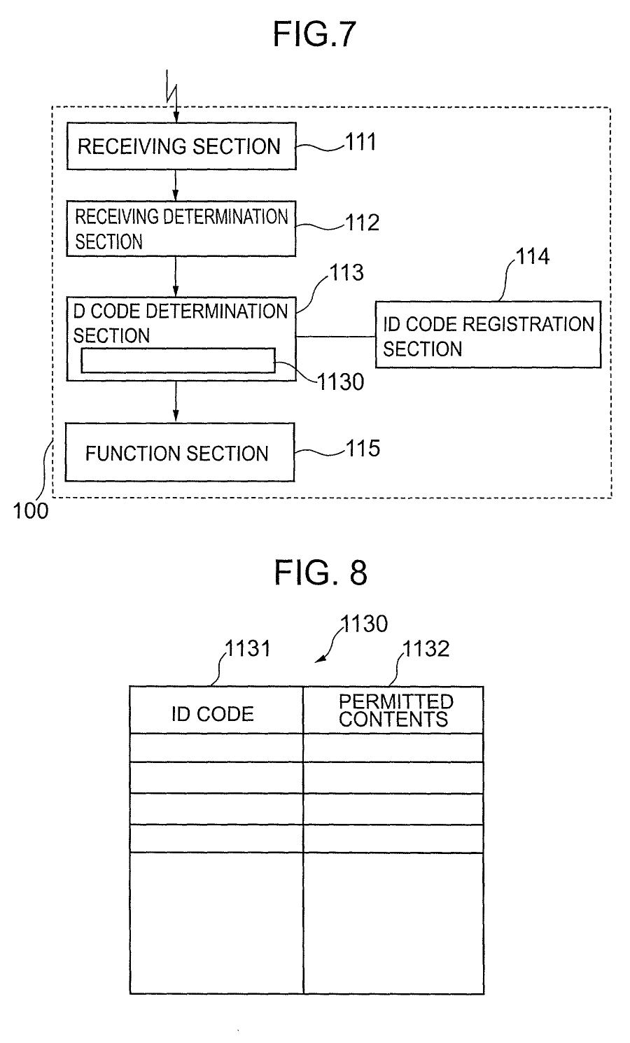

The information processor 100 has an unauthorized use prevention function such as to be used only by a person having the right to use the information processor 100. In Embodiment 2, this unauthorized use prevention function is performed according to the above-described ID code of the user identification assisting device 200. That is, the information processor 100 in Embodiment 2 is arranged so that permission/prohibition of use and the contents of usable functions (or function level) are changed according to the ID code of the user identification assisting device 200. As shown in FIG. 7, the information processor 100 has, in its internal configuration, an ID code determination section 113 and an ID code registration section 114 as well as the same components as those of Embodiment 1 (FIG. 3). Also, the receiving determination section 112 in Embodiment 2 differs partially in function from the corresponding section in Embodiment 1, as described below in detail.

The receiving determination section 112 in Embodiment 2 is arranged to extract the ID code from the signal received by the receiving section 111 and to output the extracted ID code to the ID code determination section 113 when the receiving condition is good, as well as to perform the same function as that of Embodiment 1.

The ID code determination section 113 makes a determination as to whether the ID code input from the receiving determination section 112 (i.e., the ID code contained in the signal received by the receiving section 111) is authentic, and determines a permitted group of processing operations (or function level). The ID code determination section 113 has an ID code registration table 1130 (see FIG. 8). In the ID code registration table 1130, as shown in FIG. 8, ID codes (indicated by 1131 in FIG. 8) and the contents of groups of processing operations (indicated by 1132 in FIG. 8) each of which is to be permitted when one of the ID codes is recognized are stored while being related to each other. The ID code determination section 113 makes a determination by referring to this ID code registration table 1130. The contents of this ID code registration table 1130 can be registered by the user him/herself through the ID code registration section 114.

In Embodiment 2, the ID code determination section 113 is provided and the functioning section 115 operates according to the results of determinations made by the ID code determination section 113.

The ID code registration section 114 accepts a user's operation to set the contents of the ID code registration table 1130 as desired. In this embodiment, setting of the contents of the ID code registration table 1130 is performed in a special registration mode. To make the information processor 100 proceed to operate in the registration mode, input of a predetermined password is required. However, this password is required only for registration of an ID code in the ID code registration table 1130 or the like and is not necessary for ordinary use of the information processor 100. That is, it is not necessary for the user to keep the password always in memory. In this embodiment, therefore, this password is formed so as to be sufficiently long (e.g., equal to or longer than 15 figures). The ID code registration section 114 in this embodiment comprises the same components as those described above, i.e., a display 101 and operating portions 102 (see FIG. 1), a display processing section for displaying a predetermined registration window on the display 101, and a functioning section for identifying the contents of an input provided by operating the operating portions 102. However, it is not necessary to provide these sections exclusively in the ID code registration section 114, and these sections may be common sections operating for the ID code registration section 114, the functioning section 115 and some of the other sections.

The above-described sections constituting this information processor 100 are specifically realized as memories, such as a ROM and a RAM, in which data for various controls, programs, etc., are stored, a CPU for realizing the various functions by executing the programs, transmitting and receiving circuits, etc. Specifically, this embodiment comprises a nonvolatile memory, such as a flash memory, in which the ID code registration table 1130 and the password are stored.

“Processing means” referred to in the appended claims of the present invention corresponds to the functioning section 115 in this embodiment. “Extraction means” corresponds to the receiving determination means 112. “Management information” corresponds to the ID code registration table 1130. “Discrimination code” corresponds to the ID code. “Registered code” corresponds to each ID code registered in the ID code registration table 1130. “Memory means” corresponds to the nonvolatile memory, such as a flash memory in which the ID code registration table 1130 is stored. “Received code” corresponds to the ID code contained in the signal received by the receiving section 111. “Collation means” corresponds to the ID code determination section 113. “Restriction means” is realized by the ID code determination means 113. “Registration means” is realized by the ID code registration section 114.

“Discrimination code memory means” corresponds to the ID code memory section 212. “Transmitting means” corresponds to the transmitting section 211. “Wearing means” corresponds to the belt 203. However, the above-described sections, etc., operate in intimate association with each other and the components of this embodiment and the means described in the claims are not to be construed as corresponding strictly to each other as described above.

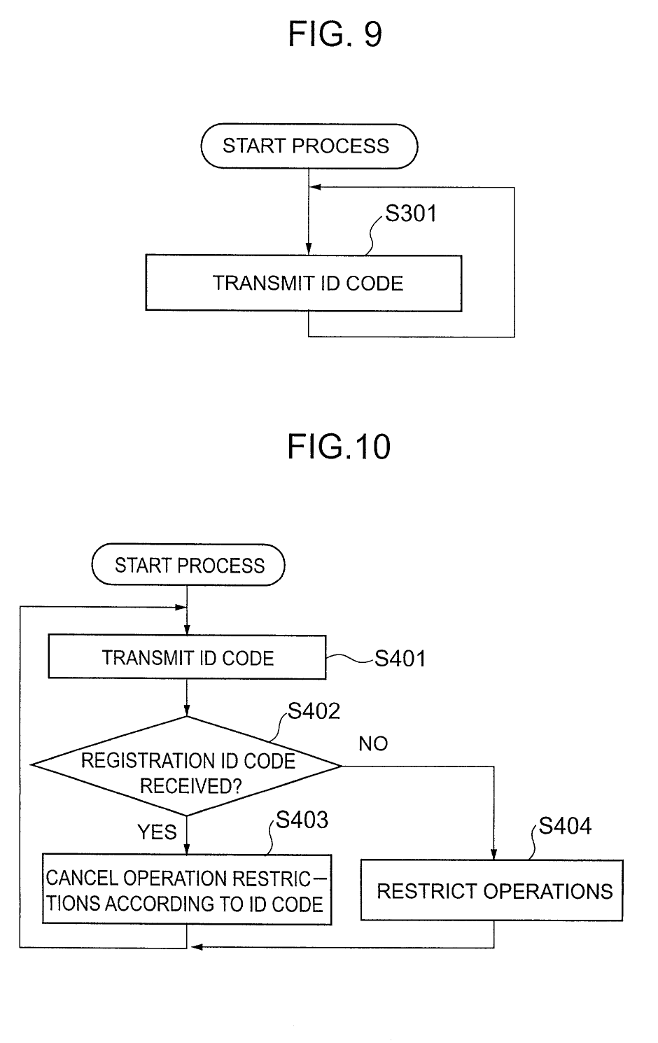

The operation of this system will now be described with reference to FIGS. 9 and 10 with respect to an unauthorized use prevention process.

The unauthorized use prevention function in this system is performed by the information processor 100 and the user identification assisting device 200 operating in association with each other. However, the operation of the information processor 100 and the operation of the user identification assisting device 200 will be described separately from each other.

The operation of the user identification assisting device 200 will first be described with reference to FIGS. 9.

The user identification assisting device 200 is worn (or fitted) about a wrist of a person like an ordinary wristwatch, with its belt 203 encircling the wrist. In this state, the transmitting section 211 of the user identification assisting device 200 reads an ID code from the ID code memory section 212, and transmits a predetermined signal including the ID code to a surrounding space at predetermined time intervals (e.g., several seconds) (step S301). The transmitted signal contains the ID code read out from the ID code memory section 212 by the transmitting section 211.

The operation of the information processor 100 will next be described with reference to FIGS. 10.

In the information processor 100, the receiving section 111 is operating to receive continuously the signal transmitted from the user identification assisting device 200. The receiving determination section 112 determines the condition of receiving of the signal by the receiving section 111. If the result of this determination is that the receiving condition is good, the receiving determination section 112 extracts the ID code from the received signal and outputs the extracted ID code to the ID code determination section 113 (step S401).

Then the ID code determination section 113 makes a determination as to whether there is a match between the extracted ID code and the ID codes registered in the ID code registration table 1130 (step S402). If a match occurs therebetween, the corresponding group of processing operations (process contents) permitted with respect to the matching ID code is recognized. This recognition is performed by referring to the ID code registration table 1130. Only the recognized group of processing operations is permitted (or restrictions on the processing operations are canceled) (step S403). Thus, the functioning section 115 can perform only the group of processing operations permitted in advance with respect to the user identification assisting device 200 having the corresponding ID code (i.e., the person carrying the user identification assisting device 200). For example, in the contents of a list of telephone numbers stored in the information processor 100, telephone numbers which are allowed to be displayed on the display 101 may be varied with respect to the ID codes. Further, the level of secrecy of data accessible with the information processor 100 may be varied with respect to the ID codes.

On the other hand, if no match is recognized as a result of the determination in step S402, the ID code determination section 113 imposes operation restrictions on all the processing operations performed by the functioning section 115 (step S404), thereby restricting any kind of use of the information processor 100. In some other case, e.g., the case of a bad receiving condition, this step S404 may be performed.

After step S403 or step S404, the process returns to step S401. The information processor 100 and the user identification assisting device 200 continually repeat the above-described steps during operation.

The operation of the information processor 100 will next be described with respect to ID code registration.

The user operates the operating portions 102 to input an instruction for proceeding to operate in the registration-only mode. Then the ID code registration section 114 displays on the display 101 a message for requesting the user to input the predetermined password. When the user inputs the password in response to this request, the ID code registration section 114 makes a determination as to whether the password is correct. If it is thereby determined that the password is correct, the information processor 100 proceeds to operate in the registration mode.

In the registration mode, the ID code registration section 114 displays the current contents of the ID code registration table 1130 on the display 101, and accepts a change instruction which is input by operating the operating portions 102. When a predetermined entry acceptance instruction is input, the operation in the registration mode is terminated and the contents of the ID code registration table 1130 are updated according to the instruction.

Embodiment 2 arranged as described above have advantages described below, as well as the same advantages as those of Embodiment 1.

A user can be identified on the basis of the ID code (strictly speaking, the user identification assisting device 200 carried by the user). It is therefore possible to finely set function restrictions with respect to different users as well as to just prevent unauthorized use. This restricting function can be advantageously used in the case of use of one information processor by a plurality of persons and further in the case with respect to a need to impose restrictions on accessible functions and data corresponding to the users, and the like. Ordinarily, users have portable information processors (including portable communication devices) in their possession for personal use and therefore store personal information in the portable information processors. Also, personal information stored therein needs to be treated with secrecy. From the viewpoint of prevention of unauthorized use, therefore, an application of the present invention to a portable information processor in the manner as described above with respect to this embodiment is particularly useful.

Further, in this embodiment, ID codes selected according to one's need can be input to the information processor 100. Therefore the information processor 100 can be used with improved flexibly. For example, one information processor 100 can be made to be used by a plurality of persons.

The embodiments have been described as a system in which a person not carrying the user identification assisting device 200 cannot use the information processor 100 whatever he or she may do. However, the arrangement may alternatively be such that restrictions on the processing operations are canceled if a predetermined password is input, regardless of ID code matching. If the information processor 100 is arranged in this manner, a person having forgotten to bring the user identification assisting device 200 can avoid a situation of not being able to use the information processor 100.

In this embodiment, ID codes and the contents of processing operations to be permitted are stored in the ID code registration table 1130 in a state of being related to each other. In the ID code registration table 1130, ID codes and the contents of groups of processing operations to be prohibited, conversely, may alternatively be stored in a state of being related to each other to achieve substantially the same function.

In this embodiment, ID codes and the contents of processing operations to be permitted are stored in the ID code registration table 1130 in a state of being related to each other. However, if there is no need to differentiate the contents of permitted processing operations for respective ID codes, that is, only enabling a plurality of persons to use the information processor 100 may suffice, no information on the contents of processing operations to be permitted (or to be prohibited) needs to provided.

Although a password is required for proceeding to operate in the ID code registration mode, it is not one for ordinary use of the information processor 100. Therefore, it can be lengthened beyond a limit determined by the human retentive faculty. Thus, the use of a password in accordance with the present invention is improved in terms of security. Moreover, ID code registration is performed by operating the operating portions 102, and the degree of secrecy with which ID code registration is performed in this manner is higher than that in the case of using electric waves or the like.

In the description of this embodiment, a portable telephone has been mentioned as a device to which the unauthorized use prevention system is applied. However, the unauthorized use prevention system of the present invention can be applied to other various information appliances, such as PDAs and personal computers. Further, the present invention can be applied not only to information appliances but also to appliances in general. For example, the present invention may be applied to the front door or a door of a room of a house, etc., to improve the security against intrusion or the like. The present invention may also be applied to a home appliance system in which when one of the occupants of a house comes home, playback of a recording in a telephone answering machine, activation of an air conditioner, turning on of illumination lamps, etc., are automatically performed. Appliances automatized in such a manner are highly convenient.

The embodiments have been described as a system in which user identification assisting devices 200 respectively have unique ID codes which are fixed and cannot be changed. However, the arrangement may alternatively be such that the ID code of each user identification assisting device 200 can be set according to one's need. For example, in an organization such as a company, ID codes may be set with respect to the official positions, divisions, etc., to set the level of use of the information processor (the functional level at which the information processor can be used) according to the official positions, places, etc.

Also, ID codes may be set with respect to different models of the user identification assisting device, to enable proper use of an appliance according to each of the types of user identification assisting devices worn by users. This method of use of ID codes is useful in a case where the user identification assisting device operates not only to assist in user identification but also to positively exchange information, etc., with the information processor. That is, this method is useful in a case where different types of user identification assisting devices differ in compatibility with certain functions. For example, use of each user identification assisting device may be optimized according to whether the user identification assisting device has a simple 7-segement display intended to mainly display numeral characters or a matrix type of display capable of displaying a comparatively complex image.

An appliance management system in accordance with this embodiment is characterized mainly in that an appliance management device 2200 carried on the body (or worn) by a possessor and an information appliance 2100 exchange ID codes to realize various functions such as a loss prevention function, as described below in detail.

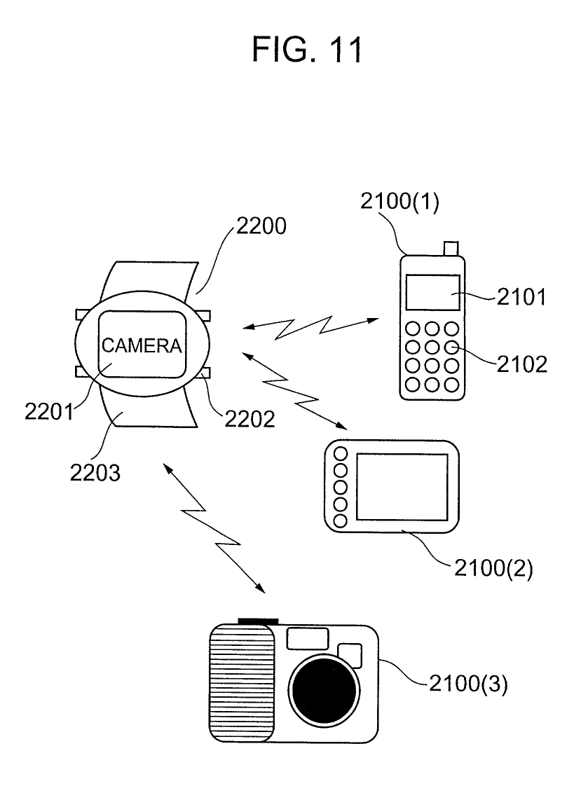

As shown in FIG. 11, this appliance management system is constituted by portable information appliances 2100 and an appliance management device 2220 used for management of use of the information appliance 2100.

The appliance management device 2200 is a device for detecting loss, mislaying or the like of each information appliance 2100 and for informing the person wearing the appliance management device 2200 of the occurrence of loss, mislaying or the like of the information appliance 2100. The appliance management device 2200 also has the function of informing each information appliance 2100 that the person carrying the appliance management device 2200 is an authorized user (a person having the right to use the information appliance 2100).

The appliance management device 2200 has, in its appearance, a display 2201 and an operating portions 2202, etc. The appliance management device 2200 is arranged to display a name of some of the information appliances on the display 2201 at the time of occurrence of loss or the like of the appliance (see FIG. 11). The appliance management device 2200 is arranged to register information appliances 2100 as monitoring targets according to the user's need by using the display 2201 and the operating portions 2202. To perform this registration, unique ID codes are entered to the information appliances 2100, as described below.

The appliance management device 2200 has a belt 2203 which enables the appliance management device 2200 to be used in a state of being worn about a wrist or the like of the user. That is, the possibility of the appliance management device 2200 itself being lost is made low. The appliance management device 2200 has a clock display function so that time, etc., are normally indicated on the display 2201, although this state of display is not illustrated in FIG. 11.

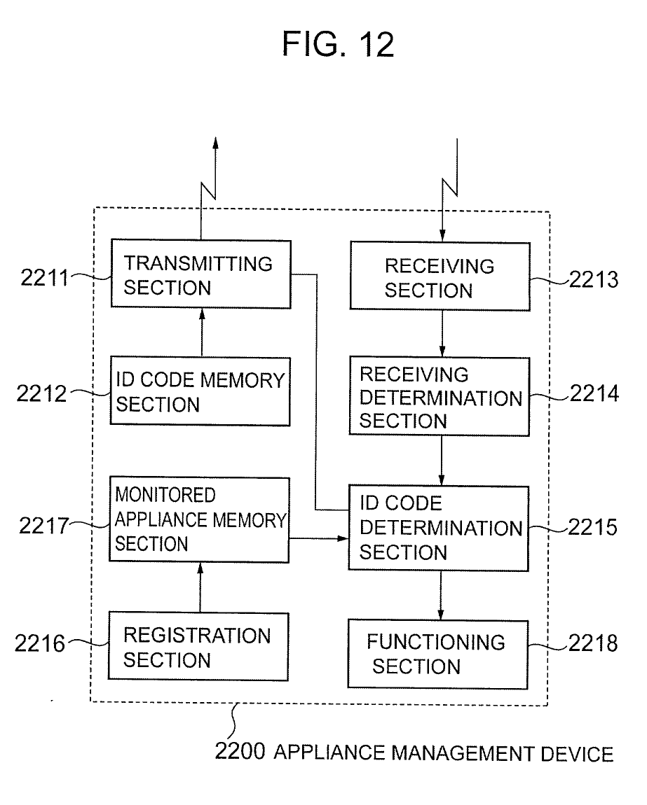

Referring to FIG. 12, the appliance management device 2200 has components for transmitting a unique ID code to the appliance management device 2200, i.e., a transmitting section 2211, and an ID code memory section 2212. The appliance management device 2200 has components for receiving, recognition, etc., of the ID code unique to each of the information appliances 2100 and transmitted from information appliance 2100, i.e., a receiving section 2213, a receiving determination section 2214, an ID code determination section 2215, a registration section 2216, a monitored appliance memory section 2217, and a functioning section 2218. In the appliance management device 2200, these sections operate in association with each other to realize an operation for positively recognizing the existence of each information appliance 2100 (inquiry operation).

Details of Each Section are as Described Below.

In the ID code memory section 2212, a unique ID code is stored in the appliance management device 2200 is stored. The contents of the ID code are factory-fixed and cannot be changed by the user. For example, the ID code memory section 2212 is constituted by a ROM.

The transmitting section 2211 outputs a signal carrying the ID code stored in the ID code memory section 2212. The area reached by the signal transmitted from the transmitting section 2211 corresponds to the area in which each information appliance 2100 can be regarded as existing without being lost, mislaid or the like. This coverage (the output power level) is set by considering the output of a transmitting section 2111 of the information appliances 2100. More specifically, the coverage of the transmitted signal is limited to several meters to several ten of meters.

The receiving section 2213 is a section for receiving a signal transmitted from each information appliance 2100.

The receiving determination section 2214 determines the condition of receiving of a signal by the receiving section 2213. The receiving determination section 2214 has in its internal portion a value (reference value) to be referred to for determination of the intensity of a signal. The receiving determination section 2214 compares this reference value and the intensity of the signal input from the receiving section 2213 to determine the condition of receiving of the signal by the receiving section 2213. If the receiving condition determined is good, the receiving determination section 2214 extracts the ID code from the signal received by the receiving section 2213, and outputs the extracted ID code to the ID code determination section 2215.

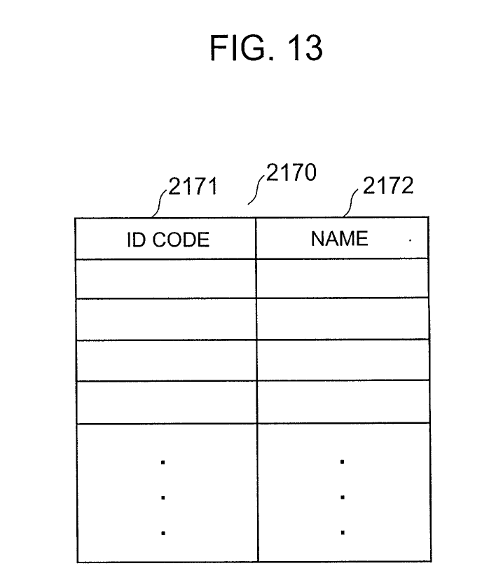

The monitored appliance memory section 2217 stores an ID code registration table 2170 or the like for registering information appliances 2100 as targets of monitoring performed by the appliance management device 2200. In the ID code registration table 2170 of this embodiment, ID codes (indicated by 2171 in FIG. 13) and the kinds or names of devices (information appliances 2100) (indicated by 2172 in FIG. 13) having the ID codes are stored in a state of being related to each other, as shown in FIG. 13. The contents of this ID code registration table 2170 can be registered by the user him/herself operating the registration section 2216. In this embodiment, the monitored appliance memory section 2217 is constituted by a flash memory.

The ID code determination section 2215 makes a determination as to whether loss or the like of some of the information appliances 2100 has occurred. This determination is made on the basis of whether a response from each monitoring-target information appliance 2100 has been recognized (in other words, whether the ID code of the information appliance 2100 has been received) within a predetermined time period after transmission of the ID code from the ID memory section 2212. Determination as to whether the received signal is a signal from one of the monitoring-target information appliances 2100 is made by referring to the above-described ID code registration table 2170. The ID code determination section 2215 outputs the result of this determination to the functioning section 2218.

With respect to one of the information appliances 2100 from which no response has been recognized as a result of this determination, the ID code determination section 2215 reads out the appliance name or the like of the information appliance 2100 from the ID code registration table 2170 and outputs the name to the functioning section 2218.

The ID code determination section 2215 also has a timing function. A transmission timer for timing of the transmission of the ID code from the transmitting section 2211, and a response timer used for determination as to whether each information appliance 2100 has been lost are realized by using the timing function of the ID code determination section 2215.

The receiving determination section 2214, the ID code determination section 2215, etc., are actually realized by a CPU executing programs stored in a memory.

The registration section 2216 accepts a user's operation to set the contents of the ID code registration table 2170 according to user's need. In this embodiment, this ID code registration table 2170 contents setting is performed in a special registration mode. The registration section 2216 in this embodiment comprises the display 2201 and the operating portions 2202 (see FIG. 11), a display processing section for displaying a predetermined registration window on the display 2201, and a functioning section for identifying the contents of an input provided by operating the operating portions 2202. However, it is not necessary to provide these sections exclusively in the registration section 2216, and these sections may be common sections operating for the registration section 2216, the functioning section 2218, and some of the other sections.

The functioning section 2218 is a section for informing the person wearing the appliance management device 2200 of occurrence of loss or the like of some of the information appliances 2100. This information is performing by displaying on the display 2201 a message that mislaying or the like has occurred and the corresponding appliance name. A buzzer is also sounded for the same information. The functioning section 2218 is also arranged to operate according to the results of determination made by the ID code determination section 2215. Data (e.g., the name of the lost appliance) required for this information is supplied from the ID code determination section 2215.

Although the functioning section 2218 is represented by only one block, it includes, in reality, various devices (e.g., a display device including display 2201, operating portions 2202 (see FIG. 11), a speaker, a buzzer, a signal and data processing circuit, and a wireless signal transmitting and receiving circuit).

The above-described sections constituting the appliance management device 2200 are specifically realized as a ROM and a RAM in which data for various controls, programs, etc., are stored, a CPU for realizing the various functions by executing the programs, transmitting and receiving circuits, a display device, etc. Each of these components is driven by a battery (not shown) incorporated in the appliance management device 2200.

Information appliances 2100(1), 2100(2), and 2100(3) will next be described.

Information appliances 2100(1), 2100(2), and 2100(3) are appliances designed for the predetermined respective purposes. In the illustrated example of the figure, the information appliance 2100(1) functions as a portable telephone, the information appliance 2100(2) as a portable information processor, and the information appliance 2100(3) as a digital camera. In the following description, when there is no need to discriminate the information appliances 2100(1), 2100(2), and 2100(3) from each other, each information appliance is referred to simply as information appliance 2100.

in this embodiment has, as well as its essential functional arrangement, a function for preventing loss or the like of the information appliance 2100 itself. This loss prevention function is performed according to the condition of receiving of the ID code transmitted from the above-described appliance management device 2200. In the following description, the loss prevention function in the functions of the information appliance 2100 will be described exclusively.

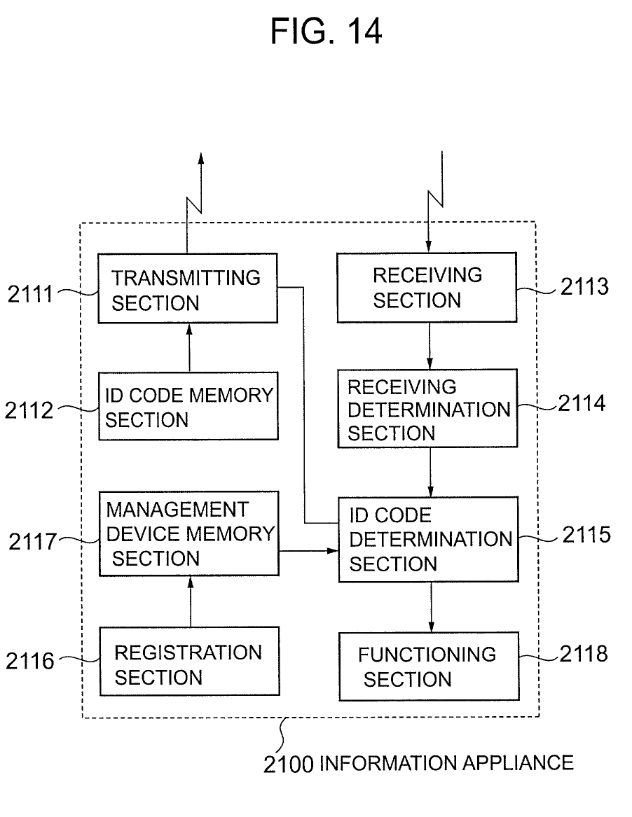

Referring to FIG. 14, the information appliance 2100 has components for transmitting an ID code unique to the information appliance 2100, i.e., a transmitting section 2111, and an ID code memory section 2112. The information appliance 2100 has components for receiving, recognition, etc., of the ID code transmitted from appliance management device 2200, i.e., a receiving section 2113, a receiving determination section 2114, an ID code determination section 2115, a registration section 2116, a management device memory section 2117, and a functioning section 2118. In the information appliance 2100, these sections operate in association with each other to realize an operation for making the existence of the information appliance 2100 known by the appliance management device 2200 by making a response to an inquiry from the appliance management device 2200 (response operation). Also, the information appliance 2100 itself checks-whether it is in a lost state on the basis of the existence/nonexistence of the inquiry from the appliance management device 2200.

Details of each section are as described below.

In the ID code memory section 2112, an ID code unique to the information appliance 2100 is stored. The specific value of the ID code are set at the time of factory-shipment and cannot be changed by the user. Specifically, the ID code memory section 2112 is constituted by a ROM.

The transmitting section 2111 outputs a signal carrying the ID code stored in the ID code memory section 2112. The area reached by the signal transmitted from the transmitting section 2111 corresponds to the area in which the information appliance 2100 can be regarded as existing without being lost, mislaid, or the like. This coverage (the output power level) is set by considering the transmitting power of the transmitting section 2211 of the appliance management device 2200. More specifically, the coverage of the transmitted signal is limited to several meters to several tens of meters.

The receiving section 2113 is a section for receiving the signal transmitted from the appliance management device 2200.

The receiving determination section 2114 determines the condition of receiving of the signal by the receiving section 2113. The receiving determination section 2114 has in its internal portion a value (reference value) to be referred to for determination of the signal intensity. The receiving determination section 2114 compares this reference value and the intensity of the signal input from the receiving section 2113 to determine the condition of receiving of the signal by the receiving section 2113. If the receiving condition determined is good, the receiving determination section 2114 extracts the ID code from the signal received by the receiving section 2113, and outputs the extracted ID code to the ID code determination section 2115.

The management device memory section 2117 is for storing the ID code of the appliance management device 2200 worn by the possessor (or manager) of the information appliance 2100.

The contents of this management device memory section 2117 can be registered by the user him/herself operating the registration section 2116. In this embodiment, the management device memory section 2117 is constituted by a flash memory.

The ID code determination section 2115 makes a determination as to whether loss or the like of the information appliance 2100 has occurred. This determination is made by confirming whether an inquiry from the appliance management device 2200 has been recognized (in other words, whether the ID code transmitted from the appliance management device 2200 has been received) within a predetermined time period. Determination as to whether the received signal is a signal from the appliance management device 2200 monitoring the information appliance 2100 is made by comparing the received ID code with the ID code registered in the management device memory section 2117.

The ID code determination section 2115 outputs the result of this determination to the functioning section 2118.

The ID code determination section 2115 also has a timing function. A receiving timer used for determination as to whether the information appliance 2100 itself has been lost or the like is realized by using the timing function of the ID code determination section 2115.

The receiving determination section 2114, the ID code determination section 2115, etc., are actually realized by a CPU executing programs stored in a memory.

The registration section 2116 accepts a user's operation to register the ID code of the management device memory section 2117. This registration is performed in a special registration mode. The registration section 2116 in this embodiment comprises the display 2101 and the operating portions 2102 (see FIG. 11), a display processing section for displaying a predetermined registration window on the display 2101, and a functioning section for identifying the contents of an input provided by operating the operating portions 2102. However, it is not necessary to provide these sections exclusively in the registration section 2116, and these sections may be common sections operating for such as the functioning section 2118.

The functioning section 2118 is a section for performing processing (loss handling processing) for coping with occurrence of loss or the like of the respective information appliances 2100. In this embodiment, loss handling processing comprises restricting the essential functions of the respective information appliances 2100 to make the information appliance 2100 unusable. Also, alarm operations, such as sounding a buzzer is performed to inform the possessor of the position of the information appliance 2100. Although the functioning section 2118 is represented by only one block, it includes, in reality, various devices (e.g., a display device including display 2101, operating portions 2102 (see FIG. 11), a microphone, a speaker, a buzzer, a signal and data processing circuit, and a wireless signal transmitting and receiving circuit). The functioning section 2118 is arranged to operate according to the results of determination made by the ID code determination section 2115.

The above-described sections constituting the information appliance 2100 are specifically realized as a ROM and a RAM in which data for various controls, programs, etc., are stored, a CPU for realizing the various functions by executing the programs, transmitting and receiving circuits, a display device, etc.

“Inquiry means” referred to in the appended claims of the present invention is realized by the transmitting section 2211, etc., of the appliance management device 2200 in this embodiment. “Response detection means” is realized by the receiving section 2213, the receiving determination section 2214, etc. “Determination means” is realized by the ID code determination portion 2215, etc. “Control Zone” corresponds to the area reached by the ID code signal transmitted by the transmitting section 2211. “Notifying means” is realized by the functioning section 2218 (display 2210, the buzzer and the like). “Management device code holding means” corresponds to the ID code memory section 2212. “Transmitting means” corresponds to the transmitting section 2211. “Appliance code memory means” corresponds to the monitored appliance memory means 2217. “Registered information” corresponds to the ID code registration table 2170.

“Registration means” corresponds to the registration section 2216 (display 2201, operating portions 2202 and the like). “Wearing means” corresponds to the belt 2203. “Inquiry detection means” is realized by the receiving section 2113 and the receiving determination means 2114 of the information appliance 2100. “Self-determination means” is realized by the ID code determination section 2115, etc. “Processing means” corresponds to the functioning section 2118 (e.g., display 2101, the buzzer). “Management device code memory means” corresponds to the management device memory section 2117. “Management device registration means” corresponds to the registration section 2116 (display section 2101, the operating portions 2102 and the like). “Appliance code holding means” corresponds to the ID code memory section 2112. “Appliance code transmitting means” corresponds to the transmitting section 2111, etc. However, the above-described sections operate in intimate association with each other and the sections of this embodiment and the means described in the claims are not to be construed as corresponding strictly to each other as described above.

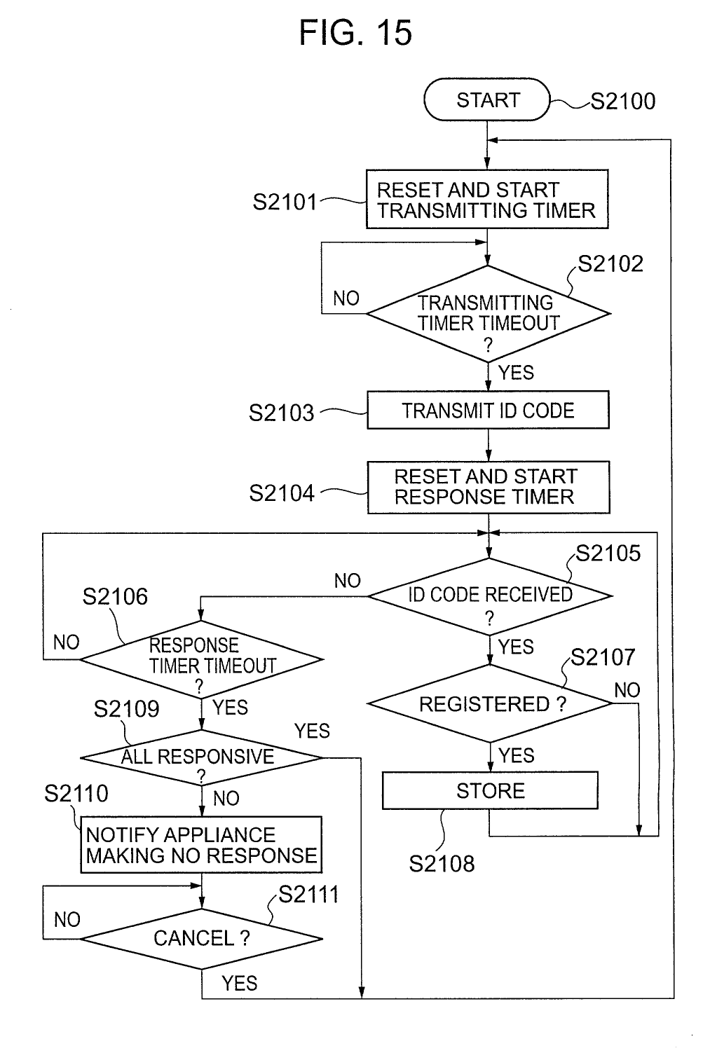

The operation of this system will now be described with reference to FIGS. 15, 16, and 17.

The function of preventing loss or the like in this system is performed by the information appliance 2100 and the appliance management device 2200 operating in association with each other. However, the operation of the information appliance 2100 and the appliance management device 2200 will be described separately from each other.

An inquiry process performed by the appliance management device 2200 will first be described with reference to FIG. 15.

The appliance management device 2200 makes a determination as to whether each monitoring-target information appliance 2100 is in such as a lost state by checking whether a response to an inquiry from the appliance management device 2200 (more specifically, transmission of the ID code) has been received from the information appliance 2100, as described below in detail.

It is assumed here that the names and the ID codes of information appliances 2100 to be monitored are registered in advance in the ID code registration table 2170 in the monitored appliance memory section 2217.

The appliance management device 2200 is worn (or fitted) about a wrist of a user like an ordinary wristwatch, with its belt 2203 encircling the wrist. The appliance management device 2200 is used in this state. During operation, the appliance management device 2200 continually executes the process shown in FIG. 15. When the process starts, the ID code determination section 2215 of the appliance management device 2200 resets the transmitting timer and starts timing with this transmitting timer (step S2101). After starting timing, the ID code determination section 2215 waits for the completion of passage of a predetermined time period (reference transmitting interval) (step S2101). After the passage of this reference transmission interval, the ID code determination section 2215 informs the transmitting section 2211 of the passage of the reference transmission interval. In response to this, the transmitting section 2211 transmits the ID code of the appliance management device 2200 stored in the ID code memory section 2212 (step S2103). Thereafter, the ID code determination section 2215 resets the response timer and starts timing with the response timer (step S104).

After starting timing with the response timer, the ID code determination section 2215 continues waiting while checking whether a predetermined time period (reference response interval) has lapsed (step S2106). During this period, the receiving section 2213, the receiving determination section 2214 and the ID code determination section 2215 are receiving ID codes transmitted from some information appliances 2100 (step S2105).

This receiving processing in step S2105 is performed specifically as described below. That is, the receiving section 2213 continuously operates to receive signals from information appliances 2100. The receiving determination section 2214 checks whether the intensity of a received signal is higher than a predetermined reference value, and also checks whether an ID code is contained in the received signal (whether an ID code has been extracted). If the level of the received signal is higher than the reference value and if some ID code is extracted, the receiving determination section 2214 outputs the extracted ID code to the ID code determination section 2215.

If an ID code has been received (extracted) in step S2105, the process advances to step S2107. In step S2107, the ID code determination section 2215 makes a determination as to whether the received ID code has been registered in the ID code registration table 2170. If the result of this determination is that the ID code has been registered (that is, the received ID code is one transmitted from one of the information appliances 2100 currently monitored by the appliance management device 2200), the ID code determination section 2215 stores information that a response from the information appliance 2100 corresponding to the ID code has been received (step S2108). The process then returns to step S2105 and the same processing is repeated. If the ID code has not been registered, the process returns from step S2107 to step S2105.

If the result of determination in step S2106 is that the time period corresponding to the reference response interval has lapsed, the process advances to step S2109. In step S2109, the ID code determination section 2215 makes a determination as to whether a response from each of the information appliances 2100 registered in the ID code registration table 2170 has been received. If the result of this determination is that replies have been received from all the information appliances 2100, the ID code determination section 2215 determines that none of the information appliances 2100 is lost, and the process returns to step S2101.

If the result of determination in step S2109 is that no response has been received from some of the information appliances 2100, the process advances to step S2110. In step S2110, the ID code determination section 2215 determines that the information appliance 2100 making no response is in a lost state, and informs the functioning section 2218 of the loss of the information appliance 2100 and the corresponding name or the like. In this event, the ID code determination section 2215 obtains the name of the information appliance 2100 by referring to the ID code registration table 2170. The functioning section 2218 receiving the information displays on the display 2201 the name of the information appliance 2100 and information that the information appliance 2100 is lost.

This display is continued until the user inputs an instruction to cancel it by operating the operating portions 2202 (step S2111). When the cancellation instruction is input, the process returns to step S2101 to repeat the same steps.

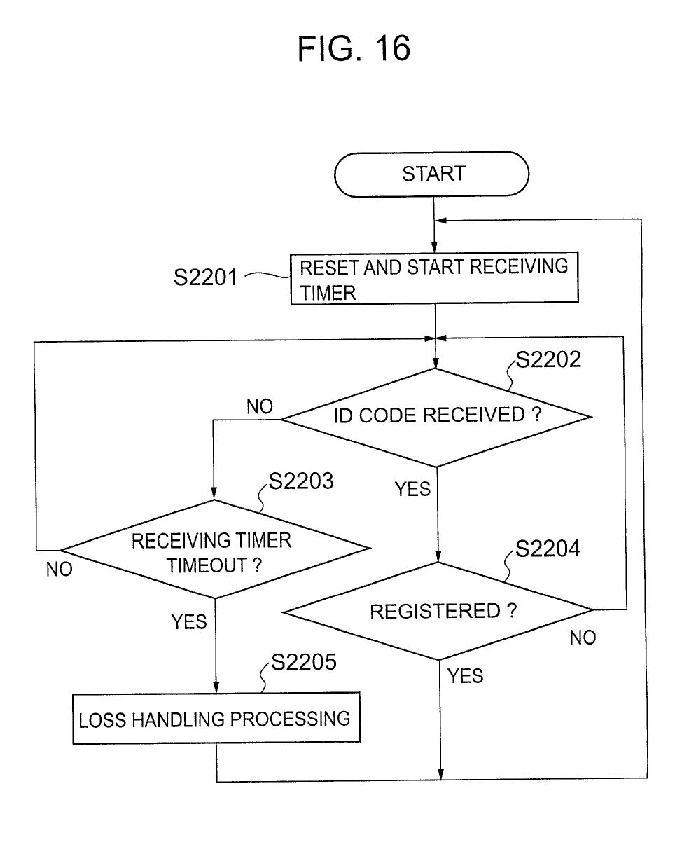

A response process performed by the information appliance 2100 will next be described with reference to FIG. 16.

The information appliance 2100 makes a determination as to whether the information appliance 2100 itself is in a lost state by checking, for every predetermined cycle, whether an inquiry from the appliance management device 2200 (more specifically, transmission of the ID code from the appliance management device 2200) has been recognized, as described below in detail.

It is assumed here that the ID code of the appliance management device 2200 monitoring the information appliance 2100 is registered in advance in the management device memory section 2117.

After a start of the process, the ID code determination section 2115 of the information appliance 2100 resets the receiving timer and starts timing with this receiving timer (step S2201).

After starting timing with the receiving timer, the ID code determination section 2115 continues waiting while checking whether a predetermined time period (reference receiving interval) has elapsed (step S2203). The length of this reference receiving interval is determined according to the reference transmitting interval timed by the transmitting timer in the appliance management device 2200.

During this time period, the receiving section 2113, the receiving determination section 2114 and the ID code determination section 2115 receive the ID code transmitted from the appliance management device 2200 (step S2202). This receiving processing in step S2202 is performed specifically as described below. That is, the receiving section 2113 continuously operates to receive the signal transmitted from the appliance management device 2200. The receiving determination section 2114 checks whether the intensity of the received signal is higher than a predetermined reference value, and also checks whether an ID code is contained in the received signal (whether an ID code has been extracted). If the level of the received signal is higher than the reference value and if some ID code is extracted, the receiving determination section 2114 outputs the extracted ID code to the ID code determination section 2115.

If an ID code has been received in step S2202, the process advances to step S2204. In step S2204, the ID code determination section 2115 makes a determination as to whether the received ID code has been registered in the management device memory section 2117. If the result of this determination is that the ID code has been registered, that is, the received ID code is the ID code transmitted from the appliance management device 2200 monitoring the information appliance 2100, then the ID code determination section 2115 determines that the information appliance 2100 is not in a lost state or the like, and the process returns to step 2201 and the same processing steps are repeated. If the ID code has not been registered, the process returns from step S2204 to step S2202.

Note that, if the result of determination in step S2203 is that the time period corresponding to the reference receiving interval has lapsed, the process advances to step S2205. In step S2205, the ID code determination section 2115 determines that the information appliance 2100 is in a lost state or the like, and instructs the functioning section 2118 to perform processing for coping with the loss of the information appliance 2100. In this embodiment, the functioning section 2118 sounds the buzzer to make the existence of the information appliance 2100 itself easily recognizable. Further, the functioning section 2118 restricts the operation of the information appliance 2100 so that the information appliance 2100 cannot be used. The process then returns to step S2201 to repeat the same steps.

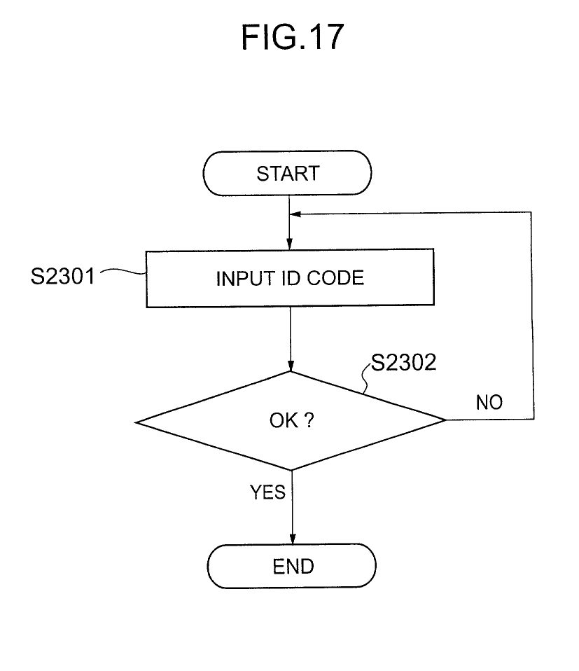

The ID code registration processes performed by the information appliance 2100 and the appliance management device 2200 will be described with reference to FIG. 17.

In the appliance management device 2200, the names and the ID codes of information appliances 2100 to be monitored are registered in the ID code registration table 2170 in the monitored appliance memory section 2217. In the information appliance 2100, the ID code of the appliance management device 2200 is registered in the management device memory section 2117. For these registrations, substantially the same registration processes are performed by the information appliance 2100 and the appliance management device 2200. Therefore, only the registration process performed by the appliance management device 2200 will be described.

Registration is performed in a special registration mode. To enable the device to proceed to operate in the registration mode, the user operates the operating portions 2202.

In the registration mode, the registration section 2216 accepts input of ID codes, etc. (step S2301). While accepting inputs, the registration section 2216 is continually checking whether an entry acceptance instruction has been input (step S2302).

Acceptance of inputs is performed as described below. That is, the registration section 2216 displays the current contents of the ID code registration table 2170 on the display 2201, and accepts a change instruction input by operating the operating portions 2202.

In step S2302, if the predetermined entry acceptance instruction has been input, the processing in the registration mode is terminated and the contents of the ID code registration table 2170 are updated according to the instruction.

In this embodiment, as described above, when one of the information appliance 2100 is lost (or about to be lost) or the like, the person wearing the appliance management device 2200 can be immediately informed of the loss of the information appliance 2100, thus enabling prevention of loss, mislaying, theft, and the like of the information appliance 2100. In the event of loss, theft or the like, a course of action to cope with it can be taken at an early time.

Further, the information appliance 2100 in a lost state uses a buzzer or the like to indicate its location, thereby enabling the possessor to easily find it. Also, use of the information appliance 2100 in a lost state is restricted to prevent unauthorized use of the information appliance 2100.

Like an ordinary wristwatch, the appliance management device 2200 can be worn (fitted) about a wrist by using the belt 2203. Therefore, the appliance management device 2200 does not interfere with the user's ordinary bodily actions, and the possibility of loss, mislaying or the like of the appliance management device 2200 itself is low.

Means for signal exchange between the information appliance 2100 and the appliance management device 2200 are not particularly specified. For example, signal exchange means in accordance with Bluetooth in the course of standardization by a certain number of companies may be used.

Ordinarily, users have portable information appliances (including portable communication devices) in their possession for personal use and therefore store personal information in the portable information appliances. Also, personal information stored therein needs to be treated with secrecy. Therefore, an application of the present invention to a portable information appliance in the manner described above with respect to this embodiment is particularly useful.

In the above-described embodiment, a user registers the kind of an appliance (e.g., camera) in the ID code registration table 2170 separate from an ID code. However, the arrangement may alternatively be such that in a portion of an ID code, information on the kind of an appliance is contained. Registration operations can be simplified in this manner.

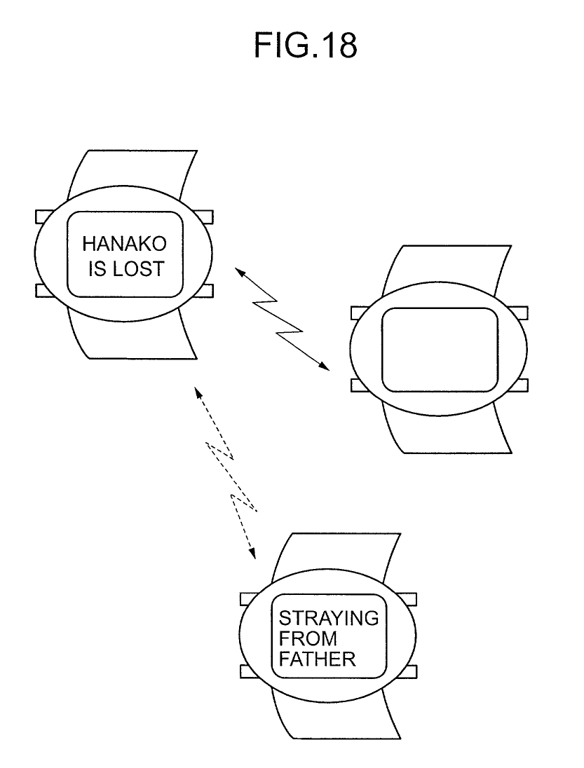

The system in the above-described embodiment is arranged to prevent loss of the information appliance 2100. However, the arrangement may also be such that appliance management devices 2200 monitor each other, as shown in FIG. 18. This mutual monitoring makes it possible to prevent persons wearing the appliance management devices 2200 from straying from each other. For example, the system thus arranged is effective in preventing a child going out with his or her parents from becoming excessively separated from the parents (e.g., straying from the parents). This function can be easily realized in such a manner that only one of the two appliance management devices 2200 performs the above-described inquiry process, and the other appliance management device 2200 performs the response process.

Also, each of a plurality of appliance management devices 2200 may perform both the inquiry and response processes. In such a case, it is possible to check through each of the appliance management devices 2200 for any straying person among those wearing the appliance management devices 2200. Each appliance management device 2200 can easily have the response function by being provided with an additional program which is stored in the memory and executed by the CPU. In such a case, the monitored appliance memory section 2217 is arranged to register the same information as that stored in the management device memory section 2117 (i.e., the ID codes of the other appliance management devices 2200).

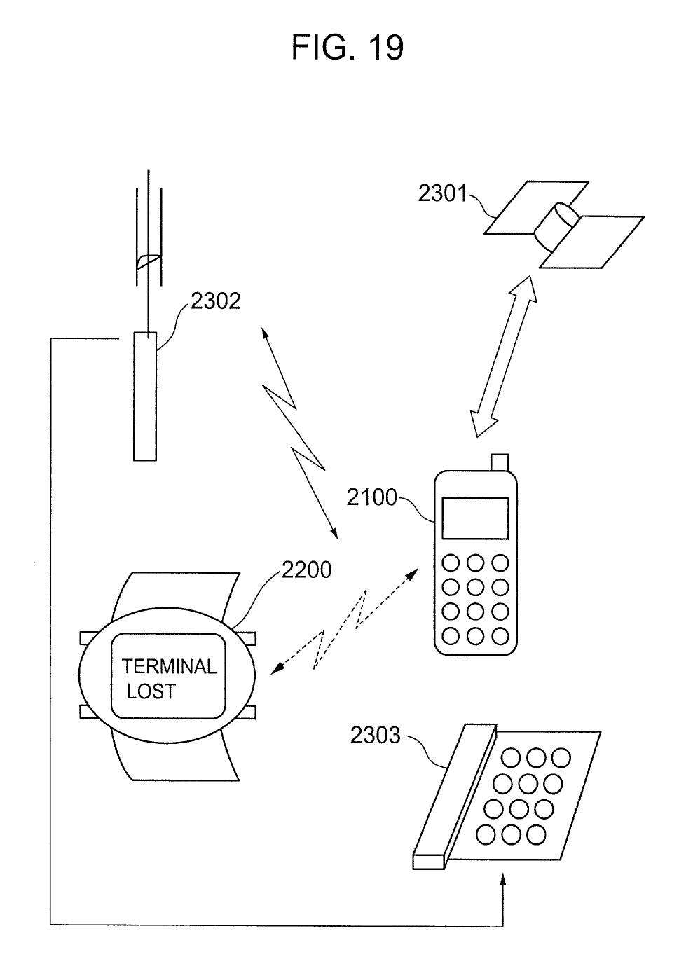

In the above-described embodiment, the information appliance 2100 in a lost state only sounds the buzzer to indicate its location. However, the information appliance 2100 may positively determine its location and send information on the location. For example, referring to FIG. 19, if the information appliance 2100 is a communication appliance (e.g., a portable telephone) having, as a function of the functioning section 2118, a global positioning function for ascertaining the location of the information appliance 2100 by using a global positioning system (GPS) satellite 2301, it may transmit data on its location to a telephone 2303 in the user's house via a base station 2302. In such a case, there is a need to previously register the telephone number of the telephone 2303 in the management device memory section 2117 or the like of the information appliance 2100. In the thus-arranged system, the information appliance in a lost state or the like can be found with improved reliability.

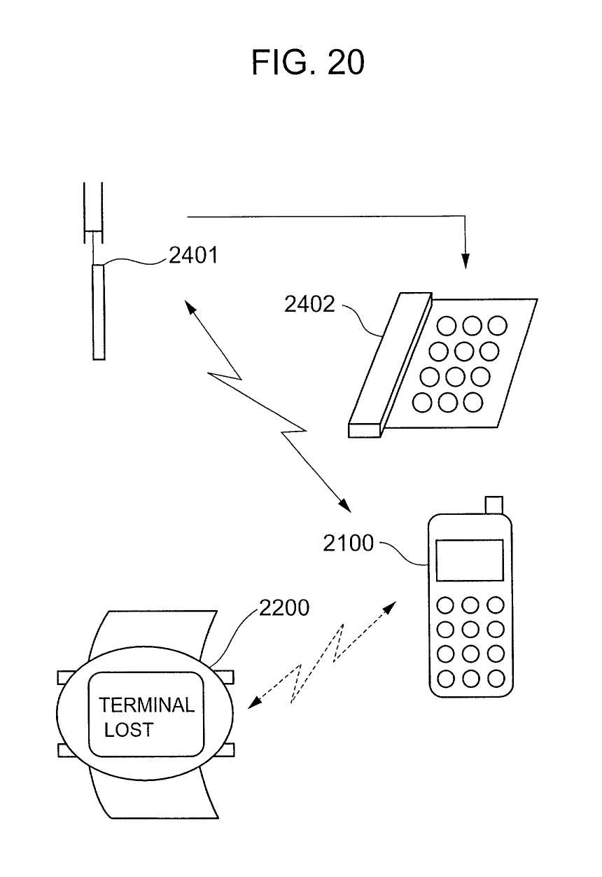

Further, if, as shown in FIG. 20, the information appliance 2100 is a terminal in the Personal Handyphone System (PHS) or the like capable of having its location ascertained by a base station 2401, it can positively provide information on its location by using the position detection service. In such a case, the information appliance 2100 stores the telephone number of a telephone 2402, which is a position notice destination, and a telephone number for using the position detection service. The information appliance 2100 in a lost state dials the telephone number for using the position detection service to inform the same of the telephone number of telephone 2402. The position detection service then detects the position of the information appliance 2100 and informs the telephone 2403 of the result of this detection. In the thus-arranged system, the information appliance 2100 in a lost state or the like can be found with improved reliability. Moreover, this system can operate at a low cost since special equipment such as that for the GPS is not required.

In implementation of the present invention, it is not necessary to use all the above-described arrangements of the present invention. Some of them may be used according to one' need.

According to the present invention, as described above, unauthorized use of an electronic device can be prevented. The convenience of the electronic device can be maintained while an authorized use prevention function is performed, as described below in detail.

According to the present invention, as long as a user authorized to use the electronic device is wearing a device (user identification assisting device) which transmits a predetermined signal, the user can be identified as an authorized user on the basis of the condition of receiving of this signal. That is, if the receiving condition is bad, the user is assumed to be unauthorized. Therefore, unauthorized use can be prevented if processes executed by the processing means are restricted according to the receiving condition. It is not necessary for the authorized user to input a password or the like, so that the present invention is also advantageous in terms of convenience.

According to the present invention, as long as a user authorized to use the electronic device is wearing a device (user identification assisting device) which transmits a predetermined discrimination code, the user can be identified as an authorized user on the basis of the discrimination code in the received signal. Therefore, unauthorized use can be prevented if processes executed by the processing means are restricted when the received code and a registered code do not match (that is, when the user is assumed to be unauthorized). Also, it is not necessary for the authorized user to input a password or the like, so that the present invention is also advantageous in terms of convenience.

According to the present invention, the contents of restrictions with respect to authorized users may be finely set while related to every discrimination codes, thereby enabling more flexible use of the electronic device.

According to the present invention, the discrimination code may be registered by the user himself/herself, thereby enabling more flexible use of the electronic device according to the user's needs.

The present invention enables prevention of unauthorized use of information processors and communication devices. Ordinarily, information such as personal information which is, preferably, treated with secrecy are stored and processed by information processors, etc., therefore, the present invention can be effectively used for prevention of unauthorized use of such devices.

According to the present invention, a user can prove his or her identity as an authorized user to the electronic device of the present invention by wearing the user identification assisting device. In this case, there is no need to input a password of the like, and this system can be conveniently used.

According to the present invention, a user wears the user identification assisting device to inform the electronic device that the user is authorized to use the electronic device (to enable the electronic device to recognize the user is authorized) without inputting a password or the like. Thus, the performance of the system in accordance with the invention is satisfactory in terms of both security and convenience.

Further, according to the present invention, loss and mislaying of the electronic device can be prevented, as described below in detail.

In the aspect of the invention, it is possible to immediately detect a move of the electronic device out of the control zone of the appliance management device (i.e., occurrence of loss, mislaying or the like of the electronic device) and to inform the user of this condition. Further, it is possible to prevent loss or the like of the electronic device by suitably setting the size of the control zone. Thus, various kinds of damage caused by loss, etc., of the electronic device can be prevented.

In the aspect of the invention, a plurality of appliance management devices may be used in the same region in combination of an electronic device having a function for discriminating the management device codes. The electronic device having such a function can identify each appliance management device, so that loss or the like of the electronic device can be prevented with improved reliability.

In the aspect of the invention, the presence of the electronic device is repeatedly checked at every predetermined time interval, so that loss or the like of the device can be prevented with improved reliability. Also, the power consumption can be reduced in comparison with a case where the management device code is transmitted continuously at all times. Therefore, this mode of implementation is particularly advantageous in a case where the appliance management device is driven by a battery. If this appliance management device is used in combination with an electronic device having a function for checking whether the electronic device itself is in a lost state on the basis of the management device code transmitted at every predetermined time interval, not only the appliance management device but also the electronic device itself can make a determination as to whether it is in a lost state.

In the aspect of the invention, it is possible to reliably detect a move of the electronic device to out of the control zone.

In the aspect of the invention, it is possible to prevent loss and mislaying of a plurality of electronic devices, so that the system is more convenient.

In the aspect of the invention, a user can know the kind and the name of any of a plurality of electronic devices such as when it is lost, and can therefore grasp the state of management more easily.

In the aspect of the invention, a user can manage electronic devices selected according to the user's need, and the versatility of the system is high.

In the aspect of the invention, a user can wear the appliance management device on the body by using a wearing means to thereby prevent loss of the appliance management device itself.

In the aspect of the invention, the electronic device itself can detect its move to out of the control zone of the appliance management device. When the electronic device moves to out of the control zone, a predetermined process is performed to prevent various kinds of damage.

In the aspect of the invention, when the electronic device is lost or in a like condition, it issues information on the name and the location of itself to be easily found.

In the aspect of the invention, the electronic device repeats checking its state at every predetermined time interval, so that loss or the like of the device can be prevented with improved reliability. This function can be used more advantageously when the electronic device is used in combination with the appliance management device which makes an inquiry about the condition of the electronic device.

In the aspect of the invention, even in a case where a plurality of appliance management devices are operated in the same region, the electronic device can identify each appliance management device. Therefore, the electronic device can makes a more accurate determination as to whether it is in such as a lost state.

In the aspect of the invention, a user can use this electronic device in combination with an appliance management device selected according to his or her need, and therefore the versatility of the system is high.

In the aspect of the invention, if the electronic device is used in combination with an appliance management device having a function for checking whether the electronic device is in a lost state on the basis of a response (transmission of the appliance code) from the electronic device, it is possible in the appliance management device to ascertain whether the electronic device itself is in a lost state.

In the aspect of the invention, it is possible for either of the appliance management device and the electronic device to ascertain whether the electronic device is within the control zone. It is, therefore, possible to perform, on both sides, processing (take steps) for coping with a loss of the electronic device or other problems. That is, it is possible to takes steps to cope with loss of the electronic device or the like more speedily. Also, when the electronic device is lost or the like, it can be found more easily. Further, loss or the like can be prevented.

What is claimed is:

1. An electronic device comprising:
processing means arranged so as to be able to execute desired processing;
receiving means for receiving a predetermined signal;
receiving condition determination means for determining the condition of receiving of the predetermined signal performed by the receiving means; and
restriction means for restricting the processing executed by the processing means if the receiving condition determination means determines that the condition of receiving is worse than a predetermined condition as a result of determination by a receiving condition determination means.

2. An electronic device comprising:
processing means arranged so as to be able to execute de sired processing;
receiving means for receiving a signal containing a predetermined discrimination code;
extraction means for extracting the discrimination code from the signal received by the receiving means;
memory means for storing management information including at least one predetermined discrimination code (hereinafter referred to as “registered code”);
collation means for collating the discrimination code extracted by the extraction means (hereinafter referred to as “received code”) with the registered code; and
restriction means for restricting the processing executed by the processing means if there is no match between the registered code and the received code as a result of the collation by the collation means.

3. An electronic device according to claim 2, wherein the management information is formed in such a manner that the registered code and the contents of a restriction with respect to the registered code are related to each other, and the restriction means restricts the processing executed by the processing means according to the contents of the management information if there is a match between any registered code and the received code as a result of the collation by the collation means.

4. An electronic device according to claim 3, further comprising registration means for accepting registration of a code entered as the discrimination code by a user, and for registering the entered discrimination code in the management information.

5. An electronic device according to claim 1, wherein the processing means is arranged so as to be able to execute at least one of the processing of data and/or a signal, and processing for transmitting a wireless signal.

6. An electronic device according to 2, wherein the processing means is arranged so as to be able to execute at least one of the processing of data and/or a signal, and processing for transmitting a wireless signal.

7. A user identification assisting device comprising:
a discrimination code memory means having a predetermined discrimination code stored therein in advance;
transmitting means for transmitting a signal containing the discrimination code; and
wearing means for enabling the user identification assisting device to be worn about the body or on a garment of a user.

8. An electronic device management system comprising:
an electronic device according to claim 1; and
a user identification assisting device according to claim.

9. An electronic device management system comprising:
an electronic device according to claim 2; and
a user identification assisting device according to claim.

10. An appliance management device for managing an electronic device, the appliance management device comprising:
inquiry means for inquiring of the electronic device about the presence/absence of the electronic device;
response detection means for detecting a response from the electronic device to the inquiry;
determination means for making a determination as to whether the electronic device is out of a control zone of the appliance management device on the basis of a result of detection performed by the response detection means; and
notifying means for issuing information that the electronic device is out of the control zone if the determination means determines that electronic device is out of the control zone.

11. An appliance management device according to claim 10, wherein the inquiry means includes:
a management device code holding means for holding in advance a discrimination code unique to the appliance management device (hereinafter referred to as “management device code”); and
transmitting means for transmitting the management device code.

12. An appliance management device according to claim 11, wherein the transmitting means transmits the management device code at predetermined time intervals.

13. An appliance management device according to claim 10, wherein the determination means determines that the electronic device is out of the control zone if the response detection means does not detect the response in a predetermined time period after the transmission of the management device code performed by the transmitting means.

14. An appliance management device according to claim 13, further comprising appliance code memory means for storing registered information containing a discrimination code unique to at least one electronic device to be managed (hereinafter referred to as “appliance code”),
wherein the response detection means receives a signal containing a discrimination code, and extracts the discrimination code from the received signal, and
wherein the determination means collates the discrimination code extracted by the response detection means with the registered information, and if the appliance code corresponding to one of the electronic devices having the appliance codes contained in the registered information is not detected by the response detection means, the determination means determines that the response has not been detected with respect to the one of the electronic devices, and that the one of the electronic device is out of the control zone.

15. An appliance management device according to claim 14, wherein the registered information is formed in such a manner that the discrimination codes unique to the electronic devices to be managed and the kinds or names of the electronic devices corresponding to the discrimination codes are related to each other, and
wherein the notifying means issues information on the kind or the name of the electronic devices recognized as existing out of the control zone by the determination means.

16. An appliance management device according to claim 15, further comprising registration means for accepting an instruction from a user to register a discrimination code as the discrimination code of the electronic devices, and for registering the discrimination code in the registered information.

17. An appliance management device according to claim 10, further comprising wearing means for enabling the appliance management device to be worn about the body or on a garment of a user.

18. An electronic device managed by an appliance management device, the electronic device comprising:
inquiry detection means for detecting an inquiry from the appliance management device;
self-determination means for making a determination as to whether the electronic device is out of a control zone of the appliance management device on the basis of a result of detection performed by the inquiry detection means; and
processing means for performing predetermined processing if the self-determination means determines that the electronic device is out of the control zone.

19. An electronic device according to claim 18, wherein the processing means performs at least one of speech generation processing for generating sound if the self-determination means determines that the electronic device is out of the control zone, and position detecting and notifying processing for detecting the position of the electronic device and notifying the detected position if the self-determination means determines that the electronic device is out of the control zone.

20. An electronic device according to claim 18, wherein the self-determination means determines that the electronic device is out of the control zone if the inquiry detection means does not detect the inquiry in a predetermined time period.

21. An electronic device according to claim 20, further comprising management device code memory means for storing a discrimination code unique to the appliance management device managing the electronic device (hereinafter referred to as “management device code”),
wherein the inquiry detection means receives a signal containing a discrimination code, and extracts the discrimination code from the received signal, and
wherein the self-determination means collates the discrimination code extracted by the inquiry detection means with the management device code, and if there is no match between the management device code and any of discrimination codes extracted by the inquiry detection means in the predetermined time period as a result of the collation, the determination means determines that the inquiry has not been detected, and that the electronic device is out of the control zone.

22. An electronic device according to claim 21, further comprising management device code registration means for accepting an instruction from a user to register a management device code, and for registering the management device code in the management device code memory means.

23. An electronic device according to claim 18, further comprising:
appliance code holding means for holding in advance a discrimination code unique to the electronic device (hereinafter referred to as “appliance code”); and
appliance code transmitting means for transmitting the appliance code to the appliance management device if the self-determination means determines that the electronic device is within the control zone of the appliance management device.

24. An appliance management system comprising:
an appliance management device according to claim 10; and
an electronic device according to claim 23.
